(19) United States
(12) Patent Application Publication
(10) Pub. No.: US 2017/0313507 A1
(43) Pub. Date: Nov. 2, 2017

(54) COMPACTING ASSEMBLY FOR TRASH RECEPTACLES

(71) Applicant: Adan Cano, North Las Vegas, NV (US)

(72) Inventor: Adan Cano, North Las Vegas, NV (US)

(21) Appl. No.: 15/141,724

(22) Filed: Apr. 28, 2016

(51) Int. Cl. B65F 1/14

(52) U.S. Cl. CPC B65F 1/1405

(57) ABSTRACT

A trash compacting assembly which is selectably coupled to a conventional front loader trash receptacle and operates to compact material disposed in the trash receptacle. The trash compacting assembly includes a base plate sized to sit on top of the top opening of the target trash receptacle, an electrical press operative to selectively generate vertical movement, a guiding system operative to transfer vertical movement from, and a compacting plate for compressing material. In operation, when the trash compacting assembly is locked in place on a target trash receptacle, a user can actuate the electrical press to cause vertical movement generated by the electrical press to be transferred to the compacting plate, by way of the guiding system, thereby moving the compacting plate such that it compresses material in the target receptacle.

### BACKGROUND OF THE INVENTION

### Field of the Invention

This invention relates generally to pressing apparatus and, more particularly, to a compacting assembly for retrofitting into existing commercial trash receptacles.

### Description of the Prior Art

The design and use of conventional front load commercial trash bins is well known. A problem which still exists, however, is that with such conventional trash bins, it is generally very difficult to make efficient use of space for the trash deposited therein. Thus, there remains need for a compacting assembly for trash receptacle which could be removably positioned in a target front loading commercial trash bin for use. It would be helpful if such a compacting assembly for trash receptacle included a locking system which allowed it to be selectively secured to the sides of a target receptacle. It would be additionally desirable for such a compacting assembly for trash receptacle to include a plurality of guiding tracks which operated to enable equal distribution of compression power on trash being compacted in the target receptacle.

The Applicant's invention described herein provides for a compacting assembly adapted to be used in conventional front loading trash receptacles to reduce the volume of the material deposited therein. The primary components in Applicant's compacting assembly for trash receptacle are an electrical press, a compacting plate a guiding system, and locking hooks. When in operation, the compacting assembly for trash receptacle enables more efficient use of the space in a front loading trash receptacle. As a result, many of the limitations imposed by prior art structures are removed.

### SUMMARY OF THE INVENTION

A trash compacting assembly which is selectably coupled to a conventional front loader trash receptacle and operates to compact material disposed in the trash receptacle. The trash compacting assembly comprises a base plate sized to sit on top of the top opening of the target trash receptacle, an electrical press operative to selectively generate vertical movement, a guiding system operative to transfer vertical movement from, and a compacting plate for compressing material. In operation, when the trash compacting assembly is locked in place on a target trash receptacle, a user can actuate the electrical press to cause vertical movement generated by the electrical press to be transferred to the compacting plate, by way of the guiding system, thereby moving the compacting plate such that it compresses material in the target receptacle.

It is an object of this invention to provide a compacting assembly for trash receptacle which could be removably positioned in a target front loading commercial trash bin for use

It is another object of this invention to provide a compacting assembly for trash receptacle which includes a locking system which allows it to be selectively secured to the sides of a target receptacle.

It is yet another object of this invention to provide a compacting assembly for trash receptacle which includes a plurality of guiding tracks which operated to enable equal distribution of compression power on trash being compacted in the target receptacle.

These and other objects will be apparent to one of skill in the art.

### BRIEF DESCRIPTION OF THE DRAWINGS

FIG. 1 is a side perspective view of a conventional front loader trash receptacle in accordance with the prior art.

FIG. 2 is a side elevational view of a cross section of a compacting assembly for trash receptacle built in accordance with the present invention having its compacting plate in a base position and locking hooks in an unlocked position.

FIG. 3 is a side elevational view of a cross section of a compacting assembly for trash receptacle built in accordance with the present invention having its compacting plate in a pressed position and locking hooks in an locked position.

### DETAILED DESCRIPTION OF THE INVENTION

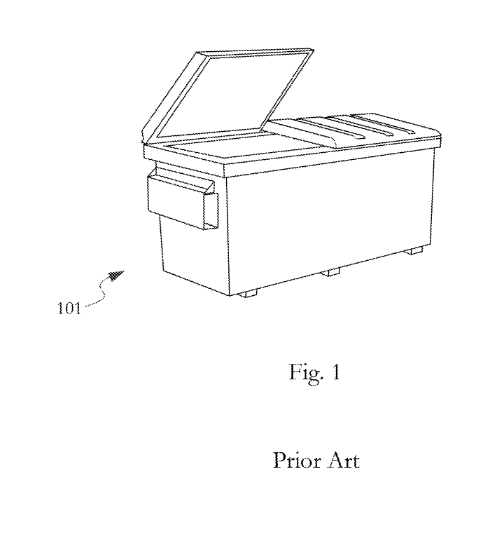

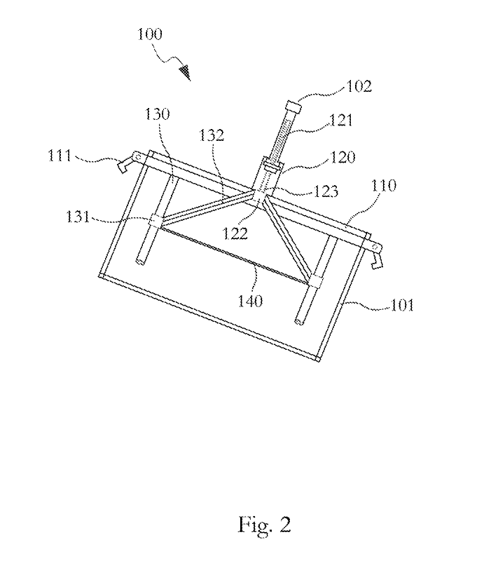

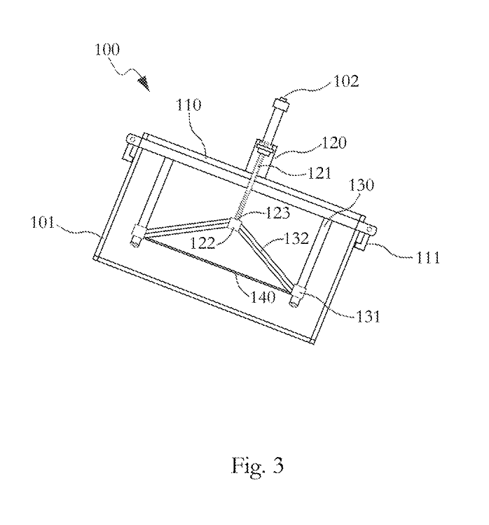

Referring now to the drawings and in particular FIGS. 1, 2, and 3, a trash compacting assembly 100 is shown as a removable apparatus for a conventional front loader trash receptacle 101. In the illustrated embodiment, the trash compacting assembly 100 includes a base plate 110, an electrical press 120, a guiding system, and a compacting plate 140. The base plate 110 defines a rigid, substantially planar member sized to extend laterally beyond the left and right side edges of the trash receptacle 101 so as to sit on top of the trash receptacle 101. Extending from each side edge of the base plate 110 is a locking hook 111. Each locking hook 111 is movably attached to the base plate 110 so as to be selectively movable between an unlocked position, as illustrated in FIG. 2, and a locked position, as illustrated in FIG. 3. In the locked position, the hooks 111 fix the base plate 110 the trash receptacle such that the base plate resists vertical movement away from the trash receptacle.

The electrical press 120 is mounted in the base plate 110 such that it is fixed in place extending both below the base plate 110 and above the base plate 110. The electrical press 120 defines a motorized screw press which operates to convert electricity to rotational movement, thereby driving a shaft 121 vertically. Attached to the base of the shaft 121 is a drive member 122. The drive member 122 includes a swivel portion 123 at its point of attachment to the shaft 121, thereby allowing the drive member 122 to move vertically with the shaft 121 without having the shaft's 121 rotation transferred thereto. In this regard, the drive member 122 maintains a set position and only moves vertically despite the rotation of the shaft 121 to which it is coupled.

The guiding system operates to transfer the movement of the drive member 113 to the compacting plate 140. In this regard, the guiding system includes two guiding rods 130, two plate holders 131, and two transfer rods 132. The guiding rods 130 are each fixed to the base plate 110, extending down therefrom vertically. The two plate holders 131, which each hold one end of the compacting plate 140, are slidably attached to the guiding rods 130 so that they can only move vertically. The transfer rods 132 are each fixed at one end to the drive member 113 and at the other end to one of the plate holders 131, thereby causing the vertical member of the drive member 122 to be transferred to the plate holders 131 and compacting plate 140.

In use, a user would position the trash compacting assembly 100 on top of a target trash receptacle 101 so that the base plate 110 extends laterally beyond the edge of the target trash receptacle 101. Then, the user would move the locking hooks 111 into the locked position. The user could then turn on the trash compacting assembly 100 by actuating a manual actuator, such as a spring biased button 102, thereby causing the electrical press 120 to move the drive member 122 (by way of the shaft 121) down. This movement is transferred to the compacting plate 140, causing it to compress material in the target trash receptacle 101.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A trash compacting assembly, comprising:
a base plate having a rigid, substantially planar surface, wherein said base plate is adapted to extend laterally beyond a left edge and right side edge of a conventional front loader trash receptacle;
at least one securing member integral with said base plate, wherein said securing member is adapted to selectively fix the base plate to the conventional front loader trash receptacle;
a press system integrated with the base plate and adapted selectively move a drive member vertically; and
a compacting plate defining a rigid planar body, wherein said compacting plate is integral with said press system such that it is moveable vertically between a base position and a compressed position.

2. The trash compacting assembly of claim 1, additionally comprising a guiding system, wherein said guiding system is adapted to connect the drive member and the compacting plate, thereby integrating the compacting plate with the drive member.

3. The trash compacting assembly of claim 2, wherein said guiding system includes a plurality of guiding rods which extend vertically from the base plate, a plurality of plate holders which are each fixed to the compacting plate and slidably disposed on one of the guiding rods, and a plurality of transfer rods which each extend between the drive member one of the plate holders.

4. The trash compacting assembly of claim 1, wherein each of said at least one securing members define a discrete locking hook which is moveable between an unlocked position and a locked position.

5. The trash compacting assembly of claim 1, wherein:
said press system defines an electrically driven motorized screw press adapted to move a threaded shaft vertically; and
said drive member is coupled with said threaded shaft.

6. The trash compacting assembly of claim 5, wherein said drive member includes a swivel portion, thereby allowing the drive member to move vertically with the shaft without having the shaft's rotation transferred thereto.

7. A trash compacting assembly, comprising:
a base plate having a rigid, substantially planar surface, wherein said base plate is adapted to extend laterally beyond a left edge and right side edge of a conventional front loader trash receptacle;
at least one securing member integral with said base plate, wherein said securing member is adapted to selectively fix the base plate to the conventional front loader trash receptacle;
a press system integrated with the base plate and adapted selectively move a drive member vertically;
a compacting plate defining a rigid planar body, wherein said compacting plate is integral with said press system such that it is moveable vertically between a base position and a compressed position; and
a guiding system, wherein said guiding system is adapted to connect the drive member and the compacting plate, thereby integrating the compacting plate with the drive member.

8. The trash compacting assembly of claim 7, wherein said guiding system includes a plurality of guiding rods which extend vertically from the base plate, a plurality of plate holders which are each fixed to the compacting plate and slidably disposed on one of the guiding rods, and a plurality of transfer rods which each extend between the drive member one of the plate holders.

9. The trash compacting assembly of claim 8, wherein each of said at least one securing members define a discrete locking hook which is moveable between an unlocked position and a locked position.

10. The trash compacting assembly of claim 8, wherein:
said press system defines an electrically driven motorized screw press adapted to move a threaded shaft vertically; and
said drive member is coupled with said threaded shaft.

11. The trash compacting assembly of claim 8, wherein said drive member includes a swivel portion, thereby allowing the drive member to move vertically with the shaft without having the shaft's rotation transferred thereto.

12. A trash compacting assembly, comprising:
a base plate having a rigid, substantially planar surface, wherein said base plate is adapted to extend laterally beyond a left edge and right side edge of a conventional front loader trash receptacle;
at least one securing member integral with said base plate and defining a discrete locking hook which is moveable between an unlocked position and a locked position, wherein said securing member is adapted to selectively fix the base plate to the conventional front loader trash receptacle when the locking hook is in the locked position;
a press system defining an electrically driven motorized screw press adapted to move a threaded shaft vertically, wherein said press system is integrated with the base plate and adapted selectively move a drive member coupled to said shaft vertically;
wherein said drive member includes a swivel portion, thereby allowing the drive member to move vertically with the shaft without having the shaft's rotation transferred thereto;
a compacting plate defining a rigid planar body, wherein said compacting plate is integral with said press system such that it is moveable vertically between a base position and a compressed position;
a guiding system, wherein said guiding system is adapted to connect the drive member and the compacting plate, thereby integrating the compacting plate with the drive member; and
wherein said guiding system includes a plurality of guiding rods which extend vertically from the base plate, a plurality of plate holders which are each fixed to the compacting plate and slidably disposed on one of the guiding rods, and a plurality of transfer rods which each extend between the drive member one of the plate holders.
